(19) United States
(12) Patent Application Publication
(10) Pub. No.: US 2022/0204402 A1
(43) Pub. Date: Jun. 30, 2022

(54) Ultra High Performance Concrete

(71) Applicant: AEEE Capital Holding & Advisory Group, Irvine, CA (US)

(72) Inventor: Mohamed J. Said, Irvine, CA (US)

(73) Assignee: AEEE Capital Holding & Advisory Group, Irvine, CA (US)

(21) Appl. No.: 17/396,736

(22) Filed: Aug. 8, 2021

Related U.S. Application Data
(63) Continuation-in-part of application No. 17/136,695, filed on Dec. 29, 2020.

(51) Int. Cl. C04B 7/32; C04B 7/14; C04B 7/02; C04B 7/345; C04B 22/00; E01D 1/00; E04C 3/20

(52) U.S. Cl. CPC C04B 7/323; C04B 7/14; C04B 7/02; C04B 7/345; E01D 2101/24; C04B 22/008; E01D 1/00; E04C 3/20; C04B 22/002

(57) ABSTRACT

A precast concrete structure formed of a cementitious mixture is provided, the cementitious mixture comprising a mixture of: (a) cement, (b) silica fume, (c) supplemental material (limestone and/or slag), (d) masonry sand, (e) water and ice (f) plasticizers and (g) workability admixtures. The result is an improved concrete for use in the formation of long span bridge elements that are simple and safe to manufacture and having improved properties. The instant abstract is neither intended to define the invention disclosed in this specification nor intended to limit the scope of the invention in any way.

### RELATED APPLICATIONS

The present application is a Continuation in Part of U.S. Ser. No. 17/136,695 filed on Dec. 29, 2020, which is incorporated by reference as if fully rewritten herein.

### BACKGROUND OF THE INVENTION

### 1. Field of the Invention

The present invention relates generally to cementitious compositions suitable for producing concrete elements and, more particularly, to an improved cementitious composition for producing ultra high performance concrete (UHPC) trademarked as EA SUPER STRENGTH CONCRETE MIX™ UHPC used in combination with designs for structural members utilizing the present teachings.

### 2. Description of the Related Art

The Precast/Prestressed Concrete Institute (PCI) provides design standards within the United States for the design and use of pre-tensioning of concrete elements. See www.pci.org. Current design limitations for concrete mixes do no allow for the creation of long span beams of the types described in the Related Art and, as such, a novel cementitious composition is required exceeding a 30,000 psi compressive strength and an 18,000 psi tensile strength.

Consequently, a need exists for cementitious composition for producing UHPC elements (UHPC) for unique long span beam designs.

### SUMMARY OF THE INVENTION

It is thus an object of the present invention to provide for easier manufacturing of UHPC elements.

It is a feature of the present invention to provide an improved cementitious composition suitable for producing such concrete elements.

Briefly described according to the present invention a cementitious mixture is provided comprising a mixture of: (a) cement, (b) silica fume, (c) supplemental material (limestone and/or slag), (d) masonry sand, (e) water and ice (f) plasticizers and (g) workability admixtures. The result is an improved concrete for use in the formation of long span bridge elements that are simple and safe to manufacture and having improved properties.

An advantage of the present invention provides an improved and novel cementitious mixtures. When used in conjunction with precast bridge beams of the Related Applications, spans from 250 feet to 350 feet in length may be provided with extended sustainability, e.g., ˜300+ year life versus ˜100 year life for traditional concrete. Such application may also be significantly cheaper (38-42%), quicker to install due to fewer intermediary columns/footings needed and no utility re-work, shoring or de-watering needed at intermediary span locations.

Further, using the UHPC of the present invention in combination with the Related Applications, beams can be made at almost half the weight of conventional concrete beams, providing ease of forming, handling, transporting and installing. And, due to high tensile strength, conventional steel reinforcing or stirrups are not needed.

With a higher density than regular concrete, elements formed of the present UHPC design, have a longer service life with negligible maintenance and improved physical-chemical properties, such as resistance to oxidation (will not rust or deteriorate), resistance to environmental degradation, impenetrable to moisture and air and are fire resistant.

Still further objects, features, elements and advantages of the invention will become apparent in the course of the following description.

### DESCRIPTION OF THE PREFERRED EMBODIMENTS

It should be understood that the legal scope of the description is defined by the words of the claims set forth at the end of this patent and that the detailed description is to be construed as exemplary only and does not describe every possible embodiment since describing every possible embodiment would be impractical, if not impossible. Numerous alternative embodiments could be implemented, using either current technology or technology developed after the filing date of this patent, which would still fall within the scope of the claims. It should also be understood that, unless a term is expressly defined in this patent there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term by limited, by implication or otherwise, to that single meaning. Finally, unless a claim element is defined by reciting the word “means” and a function without the recital of any structure, it is not intended that the scope of any claim element be interpreted based on the application of 35 U.S.C. § 112(f).

Different bridge systems designs that are structurally unique are disclosed and taught in U.S. patent application Ser. No. 17/136,695. The '695 application is incorporated by reference as if fully rewritten herein. These unique designs provide long spans including those in excess of 250 feet and those up to 350 feet. These systems provided economic and other benefits as compared with a typical or conventional system. In order to implement such designs in a structurally sound, expeditiously build and financially cheaper, the use of a UHPC mix is preferred.

In a preferred embodiment, a UHPC mix is provided according to Table 1.

TABLE 1
UHPC Mix Design

| | |
|---|---|
| Material | Quantity |

Amount per YD³

| | | |
|---|---|---|
| Cement | 1026 | pounds |
| Silica Fume | 190 | pounds |
| Supplemental Material (limestone | 114 | pounds |
| powder) | | |
| Supplemental Material (slag) | 570 | pounds |
| Masonry Sand | 1637 | pounds |
| Chilled Water* | 165 | pounds |
| Ice* | 165 | pounds |
| High-Range Water Reducer | 800 | fluid ounces |
| Workability Retaining Admixture | 100-200 | fluid ounces |
| Steel Fibers | 264 | pounds |
| (Duara or equivalent) | | |
| Polypropylene Fibers | 11 | pounds |

Water-Binder

| Flow Spread | Min 9 inches, just before | |
|---|---|---|
| | placement in product mold | |
| Min. Compressive Strength, 2-inch | 25,000 | psi |
| cubes, lab hot water cured | | |

*Total including moisture in the sand and water in the admixtures

Such a cementitious material provide cost and performance improvements and result in structurally sound novel bridge designs.

The composition according to this preferred embodiment meets all the material requirements of the PCI, including compressive and flexural strengths. Material properties include:
Initial compressive strength, f′_{ci}≥10.0 ksi;
Compressive strength at service, f′_{c}≥30 ksi;
Modulus of elasticity of concrete, E_{cm}=6500 ksi;
Residual rupture stress, fᵣᵣ=0.75 ksi; and
Concrete unit weight, w_{c}=0.155 kcf.

For purposes of the present invention, the cement should be broadly considered within a range of equivalents to include a cementitious mixture of any type known suitably for concrete formation. The cement component may preferably be a Portland cement, or blended cements including mineral admixtures or blends calcium aluminate cements, calcium sulfoaluminate cements, alkali-activated binders, supersulfated slag cements. More generally, the cement component is to be broadly construed as any cement defined in the American Society for Testing and Materials (“ASTM”) standard C150 for “Standard Specification for Portland Cement” or ASTM C595 for “Standard Specification for blended hydraulic cements” or in the European Committee for Standardization standard EN 197-1 for “Cement—Part 1: Composition, specifications and conformity criteria for common cements.

For purposes of the present invention, the silica fume or amorphous (non-crystalline) polymorph of silicon dioxide, and should be broadly construed as any material known by one having ordinary skill in the relevant art to equivalently fulfil ASTM standard C1240, “Standard Specification for Silica Fume Used in Cementitious Mixtures” or in the European Committee for Standardization standard EN 13263 “Silica fume for concrete.”

For purposes of the present invention, the water component is preferably of a composition generally known by those having ordinary skill in the relevant art as including mixing water for concrete that may including various impurities. Water fulfilling the requirement ASTM C1602/C1602M or EN 1008:2002 or similar or equivalent standards may be used.

In reference to Table 2, a comparison is shown between UHPC of the present invention and currently available cementitious mixtures of the Prior Art.

TABLE 2

| | | | Flexural* Strength | | |
|---|---|---|---|---|---|
| MANUFACTURER/ | Compressive Strength | | (ASTM 1069 Test) | | Projected |
| BRAND | PSI | Mpa | PSI | Mpa | Lifespan |
| DURA ® Concrete Canada | 24656 | 170 | 2610 | 18 | 120 YRS |
| Incorporated of Lakeshore, | | | | | |
| Ontario | | | | | |
| Cor-Tuf ® by Cor-TUF | 24770 | 170.8 | 3148 | 21.7 | 120 YRS |
| UHPC of Manassas, | | | | | |
| Virginia | | | | | |
| Lafarge/LarfargeHolcim/ | 21000 | 150 | 725 | 5 | 105 YRS |
| Ductal ® by Holcim | | | | | |
| Technology Ltd of | | | | | |
| Switzerland | | | | | |
| Hicon/Ceracem from | 15954 | 110 | 725 | 5 | 75 YRS |
| Hicon Inc. of Cincinnati, | | | | | |
| OhioACEM) | | | | | |
| BSI ® Eiffage by Eiffage | 17404 | 120 | 2393 | 16.5 | 85 YRS |
| Société Anonyme of | | | | | |
| France | | | | | |
| Densit-D Ducorit ® by | 29000 | 200 | 3,407 | 23.5 | 140 YRS |
| Illinois Tool Works, Inc. of | | | | | |
| Illinois | | | | | |
| Present Invention | 48500 | 334.00 | 7100 | 49 | 300 YRS |
| Steelike ® UHPC Mix by | 22000 | 152 | 3,600 | 25 | 100 YRS |
| Kulish Design Co., LLC of | | | | | |
| Virginia | | | | | |

*Flexural strength is one measure of the tensile strength of concrete. It is a measure of an unreinforced concrete beam or slab to resist failure in bending

In operation the preferred cementitious mixtures described herein may be used to form a concrete element such as building structures, walls, slabs, etc.), pavements, beams, columns, foundations, ceilings, façade elements as well as other articles made of concrete, such as containers, vessels, panels, plates. Such concrete elements may be further be unreinforced, reinforced or prestressed. Reinforced concrete elements may be passively reinforced with reinforcement bars made of steel, steel fibers or other structural fibers of different materials (e.g., polymeric, basalt, carbon, glass, natural fibers). Prestressed concrete elements may include prestressed steel tendons, carbon-fibre reinforced polymer (CFRP) tendons, dry or impregnated aramid fibre based tendons, glass-fibre reinforced polymer tendons (GFRP), basalt fibre reinforced polymer tendons (BFRP) and others. Prestressing be obtained by the action of the concrete expansion during the curing process. The UHPC Mix of the present invention may also be utilized for the following Industries:
Tunnels;
Explosive resistant structures; wall panels; car crash safety testing panels;
Prestress elements; deep foundations (e.g., piles); wet utility applications (such as sewers/culverts/large precast pipes); above grade retaining walls; subterranean precast/retaining walls; panic rooms; acoustical barriers; safety-vaults and etc.
Buildings: architectural slim beams, slab and column systems; long span floors and roofs;
Others: marine/sea walls and decking; storage tanks (similar to Contech)

As an example of another innovative use, when used in parking garages, UHPC of the present invention makes it possible to use “slimmer” beams, columns and decking. Such improvements increases efficient Square Foot per Stall from ˜350/SF to ˜475/SF.

The foregoing descriptions of specific embodiments of the present invention are presented for purposes of illustration and description. The Title, Background, Summary, Brief Description of the Drawings and Abstract of the disclosure are hereby incorporated into the disclosure and are provided as illustrative examples of the disclosure, not as restrictive descriptions. It is submitted with the understanding that they will not be used to limit the scope or meaning of the claims. In addition, in the Detailed Description, it can be seen that the description provides illustrative examples and the various features are grouped together in various embodiments for the purpose of streamlining the disclosure. This method of disclosure is not to be interpreted as reflecting an intention that the claimed subject matter requires more features than are expressly recited in each claim. Rather, as the following claims reflect, inventive subject matter lies in less than all features of a single disclosed configuration or operation. The following claims are hereby incorporated into the Detailed Description, with each claim standing on its own as a separately claimed subject matter.

The claims are not intended to be limited to the aspects described herein, but is to be accorded the full scope consistent with the language claims and to encompass all legal equivalents. Notwithstanding, none of the claims are intended to embrace subject matter that fails to satisfy the requirement of 35 U.S.C. § 101, 102, or 103, nor should they be interpreted in such a way. Any unintended embracement of such subject matter is hereby disclaimed. They are not intended to be exhaustive nor to limit the invention to precise forms disclosed and, obviously, many modifications and variations are possible in light of the above teaching. The embodiments are chosen and described in order to best explain principles of the invention and its practical application, to thereby enable others skilled in the art to best utilize the invention and its various embodiments with various modifications as are suited to the particular use contemplated. It is intended that a scope of the invention be defined broadly by the Drawings and Specification appended hereto and to their equivalents.

What is claimed is:

1. A beam for use in construction of a long span bridge structure comprising:
a generally vertical web extending longitudinally between a first terminus and a second terminus;
a generally horizontal planar support formed integrally with the web at an upper terminus and extending cantilever to form a pair of opposing flanges;
an enlarged bulb formed integrally with the web at a lower terminus and opposing the upper terminus, said bulb further having a horizontal lower edge, a pair of vertical opposed side edges, and tapering angularly upward from the side edges to the web;
a plurality of diaphragms formed integrally with the web and spaced apart along the beam supporting the flanges, each diaphragm spanning laterally between a side of the web and one of the flanges and the angularly upward taper of the bulb; and
a plurality of reinforcing members extending longitudinally between the first terminus and the second terminus through at least one of the group consisting of: the bulb; the web; and the horizontal planar support;
wherein the reinforcing members are prestressed and the beam is cast as a unitary body formed of an ultra high performance concrete mixture having a compressive strength exceeding 18,000 psi and comprising a mixture of:
cement;
silica flume;
limestone;
slag;
masonry sand;
water;
ice;
a shrinkage reducing admixture; and
a workability retaining admixture.

2. The beam for use in construction of a long span bridge structure of claim 1, wherein said cement is selected from a group consisting of: Portland cement; and blended cements including mineral admixtures or blends calcium aluminate cements, calcium sulfoaluminate cements, alkali-activated binders, supersulfated slag cements

3. The beam for use in construction of a long span bridge structure of claim 1, wherein said ultra high performance concrete mixture further comprises:
cement at about 24.5% by weight;
silica flume at about 4.5% by weight;
limestone powder at about 7.6% by weight;
slag at about 13% by weight;
masonry sand at about 39% by weight;
water at about 4% by weight;
ice at about 4% by weight;
a shrinkage reducing admixture at less than 2% by weight; and
a workability retaining admixture at less than 0.5% by weight.

4. The beam of claim 1, further comprising:
an end block formed at the first terminus and the second terminus, each end block formed as a vertical extension of the vertical opposed side edges between the bulb to the flanges, wherein the end block is cast from concrete as part of the unitary body; and
said plurality of diaphragms are formed as pairs between respective sides of the web and respective flanges at the same longitudinal position along the beam, wherein said pairs of diaphragms are spaced apart by a spacing distance, and wherein the spacing distance sufficient such that a load applied to an outer portion of one of the flanges will be transmitted to the web via one of the diaphragms.

5. The beam of claim 4, wherein the spacing distance is less than 30 times a flange thickness of the flanges.

6. The beam of claim 2, further comprising:
an end block formed at the first terminus and the second terminus, each end block formed as a vertical extension of the vertical opposed side edges between the bulb to the flanges, wherein the end block is cast from concrete as part of the unitary body; and
said plurality of diaphragms are formed as pairs between respective sides of the web and respective flanges at the same longitudinal position along the beam, wherein said pairs of diaphragms are spaced apart by a spacing distance, and wherein the spacing distance sufficient such that a load applied to an outer portion of one of the flanges will be transmitted to the web via one of the diaphragms.

7. The beam of claim 6, wherein the spacing distance is less than 30 times a flange thickness of the flanges.

8. The beam of claim 3 further comprising:
an end block formed at the first terminus and the second terminus, each end block formed as a vertical extension of the vertical opposed side edges between the bulb to the flanges, wherein the end block is cast from concrete as part of the unitary body; and
said plurality of diaphragms are formed as pairs between respective sides of the web and respective flanges at the same longitudinal position along the beam, wherein said pairs of diaphragms are spaced apart by a spacing distance, and wherein the spacing distance sufficient such that a load applied to an outer portion of one of the flanges will be transmitted to the web via one of the diaphragms.

9. The beam of claim 8, wherein the spacing distance is less than 30 times a flange thickness of the flanges.

10. A long span vehicle bridge structure including a plurality of beams according to claim 1.

11. A long span vehicle bridge structure including a plurality of beams according to claim 2.

12. A long span vehicle bridge structure including a plurality of beams according to claim 3.

13. A long span vehicle bridge structure including a plurality of beams according to claim 4.

14. A long span vehicle bridge structure including a plurality of beams according to claim 5.

15. A long span vehicle bridge structure including a plurality of beams according to claim 6.

16. A long span vehicle bridge structure including a plurality of beams according to claim 7.

17. A long span vehicle bridge structure including a plurality of beams according to claim 8.

18. A long span vehicle bridge structure including a plurality of beams according to claim 9.

19. A precast, prestressed concrete element consisting essentially of an ultra high performance concrete mixture have a compressive strength exceeding 18,000 psi comprising a mixture of:
cement;
silica flume;
limestone;
slag;
masonry sand;
water;
ice;
a shrinkage reducing admixture; and
a workability retaining admixture.

20. The precast, prestressed concrete element of claim 19, wherein said cement is selected from a group consisting of: Portland cement; and blended cements including mineral admixtures or blends calcium aluminate cements, calcium sulfoaluminate cements, alkali-activated binders, supersulfated slag cements

21. The precast, prestressed concrete element of claim 20, wherein said ultra high performance concrete mixture further comprises:
cement at about 24.5% by weight;
silica flume at about 4.5% by weight;
limestone powder at about 7.6% by weight;
slag at about 13% by weight;
masonry sand at about 39% by weight;
water at about 4% by weight;
ice at about 4% by weight;
a shrinkage reducing admixture at less than 2% by weight; and
a workability retaining admixture at less than 0.5% by weight.
